(19) United States
(12) Patent Application Publication
(10) Pub. No.: US 2025/0183753 A1
(43) Pub. Date: Jun. 5, 2025

(54) DAMPER DEVICE

(71) Applicant: Lanto Electronic Limited, Kunshan City (CN)

(72) Inventors: Chia-Ching HSU, Kunshan City (CN); Meng-Ting LIN, Kunshan City (CN)

(21) Appl. No.: 18/964,964

(22) Filed: Dec. 2, 2024

(30) Foreign Application Priority Data
Nov. 30, 2023 (CN) 202323262454X

(51) Int. Cl. H02K 5/24; H02K 33/18

(52) U.S. Cl. CPC H02K 5/24; H02K 33/18

(57) ABSTRACT

A damper device is provided and includes a damper pin, a damper gel groove, a frame and a case. The damper pin includes a damper pin body, a lengthening part and a damper pin tail part which are sequentially connected. The damper pin is inserted into the damper gel groove, and the damper gel groove includes a damper gel groove body and a deepening part. The deepening part is connected to the damper gel groove body, and the length of the lengthening part is less than or equal to the depth of the deepening part. The damper gel groove is disposed on the frame, and the frame includes a protrusion part. The protrusion part downwardly protrudes from the bottom of the frame and is disposed under the damper gel groove. The frame is disposed on the case.

### FIELD OF THE INVENTION

The present disclosure relates to a technical field of dampers, and particularly relates to a damper device.

### BACKGROUND OF THE INVENTION

In order to suppress a frequency response of a voice coil motor on exterior vibration (e.g. jiter), a damper pin and a gel may be disposed in the voice coil motor. The gel may be disposed in a gel groove, and the damper pin may be inserted into the gel and may move relative to the gel to suppress the frequency response of the voice coil motor on the exterior vibration.

The longer the length of the damper pin, the deeper the depth of the damper pin which is inserted into the gel. Then, the greater the contact area of the damper pin and the gel, the better the effect of suppressing the frequency response of the voice coil motor on the exterior vibration. However, when the length of the damper pin is longer and longer, the safe distance between the damper pin and the bottom of the gel groove is shorter and shorter and it would cause that the bottom of the damper pin easily collides with the bottom of the gel groove. Hence, the current damper pin has the problem that the damper pin easily collides with the bottom of the gel groove when the length of the damper pin increases.

### SUMMARY OF THE INVENTION

The object of the present disclosure is to provide a damper device which has an advantage that the damper pin does not easily collide with the bottom of the damper gel groove when the length of the damper pin increases. The damper device includes a damper pin, a damper gel groove, a frame and a case. The damper pin includes a damper pin body, a lengthening part and a damper pin tail part which are sequentially connected. The damper pin is inserted into the damper gel groove, and the damper gel groove includes a damper gel groove body and a deepening part. The deepening part is connected to the damper gel groove body, and the length of the lengthening part is less than or equal to the depth of the deepening part. The damper gel groove is disposed on the frame, and the frame includes a protrusion part. The protrusion part downwardly protrudes from the bottom of the frame and is disposed under the damper gel groove. The frame is disposed on the case.

In some embodiments, the damper pin body includes a damper pin first body and a damper pin second body, and the damper pin first body, the lengthening part and the damper pin second body are sequentially connected.

In some embodiments, the shape and the size of a cross section of the damper pin body are equal to the shape and the size of a cross section of the lengthening part.

In some embodiments, the damper pin body and the lengthening part are coaxially disposed.

In some embodiments, the shape and the size of a cross section of the damper gel groove body are equal to the shape and the size of a cross section of the deepening part.

In some embodiments, the damper gel groove body and the deepening part are coaxially disposed.

In some embodiments, the damper device further includes a motion component, and the motion component is movably disposed relative to the frame, and the motion component and the frame are separate, and the damper pin is connected to the motion component.

In some embodiments, the protrusion part contacts the case.

In some embodiments, the protrusion part and the damper gel groove are coaxially disposed.

In some embodiments, a height of the protrusion part is greater than or equal to a depth of the deepening part.

In some embodiments, the case includes a recession part and the protrusion part is located on and contacts the recession part.

In some embodiments, the number of the recession parts and the number of the protrusion parts are all at least four, and the recession parts are correspondingly disposed with the protrusion parts one by one.

In some embodiments, the depth of the recession part is less than or equal to the height of the protrusion part.

In some embodiments, the deepening part extends to the inside of the protrusion part.

In some embodiments, the bottom position of the deepening part is lower than the top position of the protrusion part.

The present disclosure discloses: a damper pin, a damper gel groove, a frame and a case. The damper pin includes a damper pin body, a lengthening part and a damper pin tail part which are sequentially connected. The damper pin is inserted into the damper gel groove, and the damper gel groove includes a damper gel groove body and a deepening part. The deepening part is connected to the damper gel groove body, and the length of the lengthening part is less than or equal to the depth of the deepening part. The damper gel groove is disposed on the frame, and the frame includes a protrusion part. The protrusion part downwardly protrudes from the bottom of the frame and is disposed under the damper gel groove. The frame is disposed on the case.

Because the length of the lengthening part of the damper pin is less than or is equal to the length of the deepening part of the damper gel groove, the distance between the damper pin and the bottom surface of the damper gel groove would not decrease when the length of the damper pin increases, and thus, the damper pin does not easily collide with the bottom of the damper gel groove.

The aforementioned description of the present disclosure is merely the outline of the technical solutions of the present disclosure. In order to understand the technical solutions of the present disclosure clearly and to implement the present disclosure according to the content of the specification. The better embodiments of the present disclosure given herein below with accompanying drawings are used to describe the present disclosure in detail.

### THE DRAWINGS

FIG. 1 is a 3D diagram of a damper device according to one embodiment of the present disclosure.

FIG. 2 is a partial cross section view diagram of a damper device according to one embodiment of the present disclosure.

FIG. 3 is a cross section view diagram of a damper pin according to one embodiment of the present disclosure.

FIG. 4 is a cross section view diagram of a damper gel groove according to one embodiment of the present disclosure.

FIG. 5 is a cross section view diagram of a damper pin according to another embodiment of the present disclosure.

FIG. 6 is an exploded view diagram of a frame and a case according to another embodiment of the present disclosure.

FIG. 7 is a partial cross section view diagram of a damper device according to yet another embodiment of the present disclosure.

### DETAILED DESCRIPTION

The specific embodiments of the present disclosure given herein below is used to explain the implementation of the present disclosure. A person skilled in the art easily understands the advantages and the effects of the present disclosure from the content of the present disclosure.

It should be noted that the embodiments and the features in the embodiments of the present disclosure can be combined with each other without conflict. The present disclosure will be described in detail below with reference to accompanying drawings and in conjunction with the embodiments. In order to provide those in the art with better understanding of the solution of the disclosure, the technical solutions in the embodiments of the present disclosure will be described clearly and completely below in conjunction with the accompanying drawings in the embodiments of the present disclosure. Apparently, the described embodiments are merely a part of the embodiments of the present disclosure and not all embodiments of the present disclosure. Based on the embodiments of the present disclosure, all other embodiments obtained by a person skilled in the art shall fall within the scope of protection of the present disclosure.

It should be noted that the terms “first”, “second”, etc. in the specification and claims of the present disclosure and in the aforementioned accompanying drawings are used to distinguish similar objects and need not be used to describe a particular order or sequence. Furthermore, the terms “comprising” and “having”, and any variation thereof, are intended to encompass a non-exclusive inclusion, for example, a series of steps or units comprising processes, methods, systems, products or equipment need not be limited to those steps or units clearly listed but may include other steps or units not clearly listed or inherent to those processes, methods, products or equipment.

It should be noted that the terms “mount”, “connect”, “link” should be broadly interpreted, for example, may be a permanent connection, may be a dismountable connection or may be an integral connection; may be a mechanical connection or may be an electrically connection; may be a direct connection, may be a connection by intermediate mediums, or may be an interior connection between two components. For a person skilled in the art, the meaning of the aforementioned terms in the present disclosure may be understood upon specific situations.

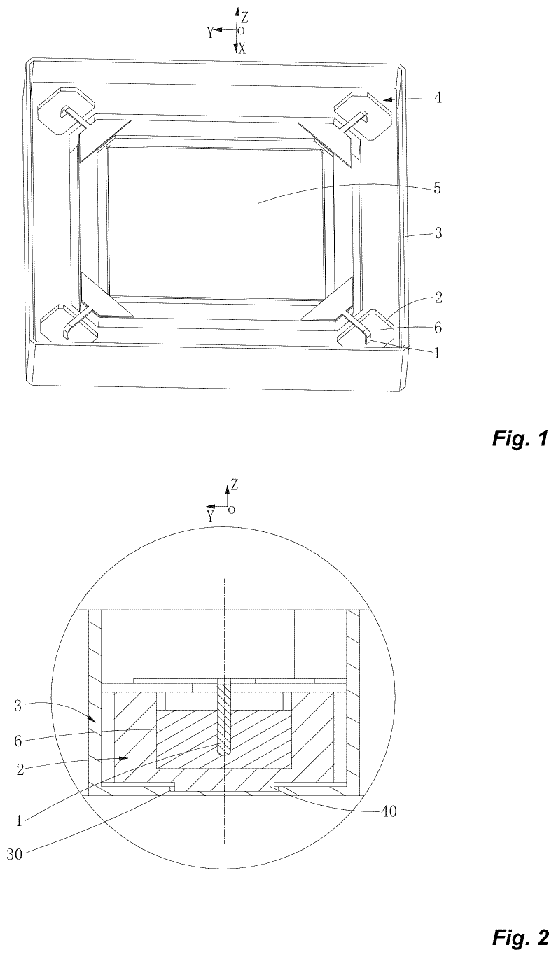

Please refer to FIG. 1 to FIG. 4. The damper device includes a damper pin 1, a damper gel groove 2, a frame 4 and a case 3. The damper pin 1 includes a damper pin body 10, a lengthening part 11 and a damper pin tail part 12, and the damper pin body 10, the lengthening part 11 and the damper pin tail part 12 are sequentially connected. The damper pin 1 is inserted into the damper gel groove 2, and the damper gel groove 2 includes a damper gel groove body 20 and a deepening part 21 connected to the damper gel groove body 20, and the length of the lengthening part 11 is less than or equal to the depth of the deepening part 21. The damper gel groove 2 is disposed on the frame 4, and the frame 4 includes a protrusion part 40. The protrusion part 40 downwardly protrudes from the bottom of the frame 4 and is disposed under the damper gel groove 2. The frame 4 is disposed on the case 3.

Please refer to FIG. 1 and FIG. 2. Specifically, the damper device is provided by the present embodiment and includes the case 3, the frame 4 and a motion component 5. The damper gel groove 2 is disposed on the frame 4, and the frame 4 is disposed on the case 3. The damper gel groove 2 and the frame 4 may be integrally formed. The frame 4 may be stacked inside the case 3. The frame 4 is embedded in and contacts the case 3. The shape of the case 3 may be a rectangular parallelepiped groove shape. The frame 4 may be a rectangular parallelepiped ring shape, and in other words, the middle of the frame 4 may include a rectangular parallelepiped through hole which passes through the frame 4.

Please refer to FIG. 1 and FIG. 2. The motion component 5 is movably disposed relative to the frame 4, and the motion component 5 and the frame 4 are separate, and the damper pin 1 is connected to the motion component 5. The shape of the motion component 5 may be a rectangular parallelepiped, and the motion component 5 is embedded in the rectangular parallelepiped through hole on the middle of the frame 4. The motion component 5 and the frame 4 are separately disposed. The motion component 5 may move along the radial direction of the frame 4 relative to the frame 4; or the motion component 5 may along the axial direction of the frame 4 relative to the frame 4. The four damper pins 1 are respectively disposed on the four corners of the upper part of the frame 4, and the four damper gel grooves 2 are respectively disposed on the four corners of the upper part of the frame 4. The damper gel 6 is injected into each of the four damper gel grooves 2. The four damper pins 1 are correspondingly disposed with the four damper gel grooves 2. The shape of the damper pin 1 may be a bar shape, and preferably, the shape of the damper pin 1 is a rectangular parallelepiped.

For convenience to explain, Cartesian coordinate system O-xyz may be disposed in FIG. 1 to FIG. 7. X-axis may be parallel to the width direction of the case 3. Y-axis may be parallel to the length direction of the case 3. Z-axis may be parallel to the thickness direction of the case 3. The damper pin 1 may be disposed in parallel with the z-axis. The positive direction of the x-axis, the positive direction of the y-axis and the positive direction of the z-axis are equal in FIG. 1 to FIG. 7.

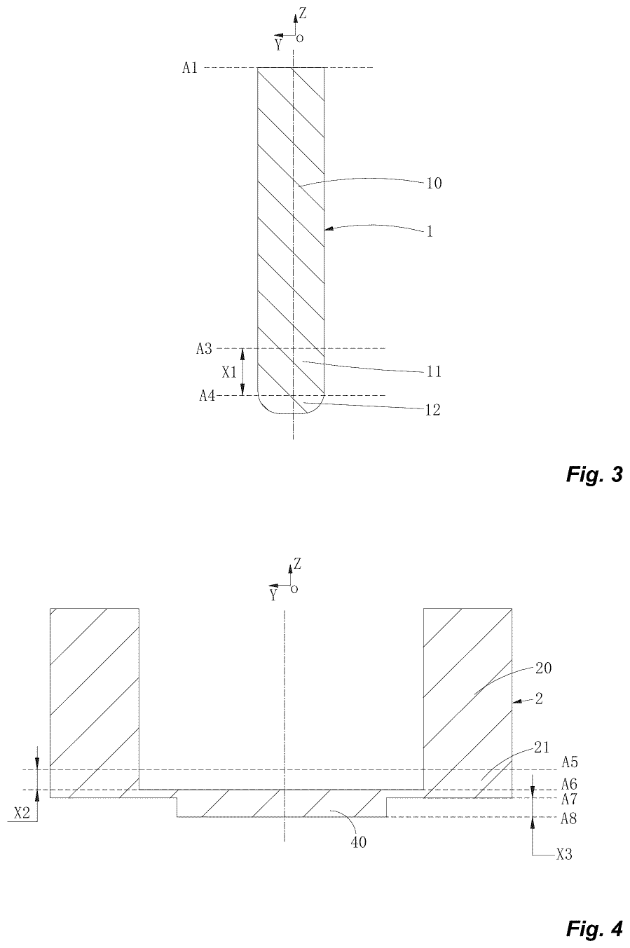

Please refer to FIG. 1, FIG. 3, and FIG. 4. The motion component 5 may drive each of the four damper pins 1 to move along a direction vertical to the z-axis relative to the frame 4 or move along the z-axis relative to the frame 4. The damper pin 1 may move in the damper gel 6 along the radial direction of the damper pin 1 or may move in the damper gel 6 along the axial direction of the damper pin 1. For example, the damper pin 1 may move in the damper gel 6 along the direction vertical to the z-axis or may move in the damper gel 6 along the z-axis. The damper pin body 10 and the lengthening part 11 may be connected by integrally forming. The damper gel groove body 20 and the deepening part 21 may be connected by integrally forming. For example, the depth of the damper gel groove body 20 may be equal to the depth of the current damper gel groove, and the part of the current damper gel groove of which the length is equal to the length of the deepening part 21 is removed and then, the removed current damper gel groove may be regarded as the damper gel groove 2 in the present embodiment.

Please refer to FIG. 1, FIG. 2, and FIG. 6. Optionally, the frame 4 includes a protrusion part 40 contacting the case 3. The number of the protrusion parts 40 may be four, and for example, the four protrusion parts 40 may be disposed on the four corners of the bottom part of the frame 4. The shape of the cross section of the protrusion part 40 may be a circle. The top of the protrusion part 40 may contact the bottom of the frame 4. The bottom of the protrusion part 40 may contact the bottom surface of the inside of the case 3. The protrusion part 40 may be integrally formed with the frame 4, and the protrusion part 40 may be welded on the bottom of the frame 4 by welding. The cross section area of the protrusion part 40 is less than the area of the bottom of the frame 4.

Please refer to FIG. 1, FIG. 2, FIG. 4, and FIG. 6. Optionally, the protrusion part 40 downwardly protrudes from the bottom of the frame 4 and is disposed under the damper gel groove 2. Because the deepening part 21 would result in the reduction of the thickness of the bottom of the damper gel groove 2, the protrusion part 40 disposed under the damper gel groove 2 may compensate the thickness of the bottom of the damper gel groove 2 to avoid the excessive reduction of the thickness of the bottom of the damper gel groove 2. The protrusion part 40 may protrude along the direction parallel to the negative direction of the z-axis. The protrusion part 40 and the damper gel groove 2 are coaxially disposed. The coaxial disposal of the protrusion part 40 and the damper gel groove 2 may prevent the protrusion part 40 from only generating support force on the partial regions of the bottom of the damper gel groove 2, and thus the protrusion part 40 may support the most regions of the bottom of the damper gel groove 2.

Please refer to FIG. 1, FIG. 2, and FIG. 6. Optionally, the case 3 includes a recession part 30, and the protrusion part 40 is embedded in and contacts the recession part 30. The recession part 30 may be a circle groove, and the bottom surface of the protrusion part 40 may contact the bottom surface of the inside of the recession part 30. The recession part 30 may be formed by downwardly recessing from the bottom surface of the inside of the case 3. The recession part 30 and the case 3 may be integrally formed. The shape of the cross section of the recession part 30 may be a circle. The shape and the size of the cross section of the protrusion part 40 may be less than the shape and the size of the cross section of the recession part 30. The cross section area of the recession part 30 is less than the bottom area of the case 3. The protrusion part 40 which is embedded in and contacts in the recession part 30 may prevent the frame 4 from excessively moving along the direction vertical to the z-axis relative to the frame 4, and it is convenient for the frame 4 to position on the case 3.

Please refer to FIG. 1 and FIG. 2. Optionally, the number of the recession parts 30 and the number of the protrusion parts 40 are all at least four, and at least four recession parts 30 are correspondingly disposed with at least four protrusion parts 40 one by one. Each recession part 30 may be disposed under the corresponding protrusion part 40. By the configuration of at least four recession parts 30 and at least four protrusion parts 40, the stability when the frame 4 is placed on the case 3 may be improved to prevent the frame 4 from falling down. For example, the number of the recession parts 30 and the number of the protrusion parts 40 may be all four, and four recession parts 30 correspond to four protrusion parts 40 one by one.

Please refer to FIG. 1, FIG. 2. Optionally, the depth of the recession part 30 is less than or is equal to the height of the protrusion part 40. The depth of the recession part 30 is less than the height of the protrusion part 40, and in other words, the bottom of the frame 4 may be lifted away from the inner surface of the case 3 by the protrusion part 40. The configuration of the recession part 30 of which the depth is less than the height of the protrusion part 40 may cause the bottom of the frame 4 to lift away from the inner surface of the case 3, thereby avoiding the entire bottom surface of the frame 4 from protruding downward to contact the case 3. In other words, there is no need to thicken the entire bottom of the frame 4 to increase the thickness of the damper gel groove 2, and thus, the materials of the protrusion part 40 may be saved.

As shown in FIG. 3, the bottom of the damper pin body 10 may be connected to the top of the lengthening part 11. The bottom of the lengthening part 11 may be connected to the top of damper pin tail part 12. The damper pin body 10 and the damper pin tail part 12 constitute the damper pin in the prior art. The damper pin body 10, the lengthening part 11 and the damper pin tail part 12 constitute the damper pin 1 in the present embodiment, and in other words, the damper pin 1 in the present embodiment is longer than the damper pin in the prior art by the length X1 of the lengthening part 11. Due to the lengthening part 11, the contact length of the damper pin 1 and the damper gel 6 in the present embodiment would at least increase the length X1 of the lengthening part 11 in comparison with the damper pin in the prior art. The top position of the damper pin body 10 remains the same as the top position of the damper pin in the prior art. The damper pin tail part 12 is the round head part of the tail of the damper pin.

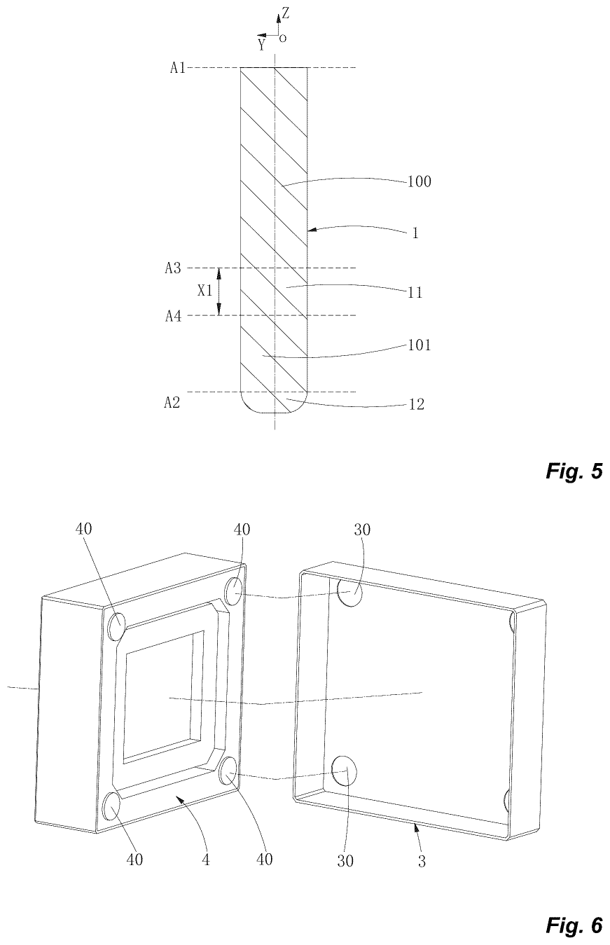

As shown in FIG. 3, the plane in parallel with XOY plane passing through the top surface of the damper pin is denoted as a plane A1, and the plane in parallel with XOY plane passing through the top surface of the damper pin tail part 12 is denoted as a plane A2 (the plane A2 may refer to FIG. 5). The planes in parallel with XOY plane passing through the top surface of the lengthening part 11 and the bottom surface of the lengthening part 11 are denoted as a plane A3 and a plane A4, and the part of the damper pin 1 located between the plane A3 and the plane A4 is the lengthening part 11 and the distance between the plane A3 and the plane A4 is the length X1 of the lengthening part 11.

As shown in FIG. 4, the deepening part 21 is located on the bottom of the damper gel groove body 20. The bottom of the damper gel groove body 20 may be connected to the top of the deepening part 21. The depth of the damper gel groove 2 in the present embodiment is deeper than the depth of the damper gel groove in the prior art by the depth X2 of the deepening part 21. The plane in parallel with XOY plane passing through the bottom surface of the damper gel groove body 20 is denoted as a plane A5, and the plane in parallel with XOY plane passing through the bottom surface of the deepening part 21 is denoted as a plane A6, and the part of the damper gel groove 2 between the plane A5 and the plane A6 is the deepening part 21, and the distance between the plane A5 and the plane A6 is the depth X2 of the deepening part 21. The length X1 of the lengthening part 11 (the lengthening part 11 may refer to FIG. 3) is less than or be equal to the depth X2 of the deepening part 21.

Because the length X1 of the lengthening part 11 of the damper pin 1 is less than or be equal to the length X2 of the deepening part 21 of the damper gel groove 2, the distance between the damper pin 1 and the bottom surface of the damper gel groove 2 would not decrease when the length of the damper pin 1 increases, and thus, the damper pin 1 would not easily collide with the bottom of the damper gel groove 2.

As shown in FIG. 3, optionally, the plane A4 and the plane A2 may coincide. The damper pin body 10, the lengthening part 11 and the damper pin tail part 12 may be connected by integrally forming. To prevent the sharp edge of the damper pin tail part 12 from puncturing the damper gel 6, the damper pin tail part 12 usually requires chamfering (the structure of the damper pin tail part 12 is a round head). Hence, when the lengthening part 11 is the damper pin tail part 12, the lengthening part 11 also requires chamfering. When the lengthening part 11 is chamfered, the contact area between the lengthening part 11 and the damper gel 6 would decrease and the ability of the lengthening part 11 about suppressing the frequency response of the voice coil motor on the exterior vibration declines. The lengthening part 11 is disposed between the damper pin body 10 and the damper pin tail part 12, and the surface of the damper pin tail part 12 is a chamfered arc surface, and thus, there is no need to chamfer the lengthening part 11, and further, the contact area between the lengthening part 11 and the damper gel 6 may remain the same.

As shown in FIG. 3, optionally, the shape and the size of the cross section of the damper pin body 10 are equal to the shape and the size of the cross section of the lengthening part 11. The shape of the cross section of the damper pin body 10 and the shape of the cross section of the lengthening part 11 may be rectangles. Optionally, the damper pin body 10 and the lengthening part 11 are coaxially disposed. Because the shape and the size of the cross section of the damper pin body 10 are equal to the shape and the size of a cross section of the lengthening part 11 and the damper pin body 10 and the lengthening part 11 are coaxially disposed, there is a smooth transition between the side surface of the damper pin body 10 to the side surface of the lengthening part 11 to prevent the lengthening part 11 from protruding along the radial direction of the damper pin body 10 and to avoid the lengthening part 11 protruding along the radial direction of the damper pin body 10 from puncturing the damper gel 6 along the direction parallel to the z-axis.

As shown in FIG. 4, optionally, the shape and the size of the cross section of the damper gel groove body 20 are equal to the shape and the size of the cross section of the deepening part 21. Because the shape and the size of the cross section of the damper gel groove body 20 are equal to the shape and the size of the cross section of the deepening part 21, the depth of the deepening part 21 may be directly changed based on the current damper gel groove when the deepening part 21 is manufactured and there is no need to change the size of the cross section of the deepening part 21 so that the manufacturing of the deepening part 21 is more convenient.

As shown in FIG. 4, the shape of the cross section of the damper gel groove body 20 and the shape of the cross section of the deepening part 21 may be polygonal. For example, the shape of the cross section of the damper gel groove body 20 and the shape of the cross section of the deepening part 21 may be octagons. The damper gel groove body 20 and the deepening part 21 are coaxially disposed. Because the damper gel groove body 20 and the deepening part 21 are coaxially disposed, the damper pin 1 does not easily contact the sidewall of the deepening part 21 during movement. Under the condition that the damper gel groove body 20 is not coaxially disposed with the deepening part 21 and the shape of the cross section of the damper gel groove body 20 and the shape of the cross section of the deepening part 21 are equal, one part of the deepening part 21 would protrude along the direction vertical to the z-axis so that the damper pin 1 collides with one part of the deepening part 21 during movement (the moving direction of the damper pin 1 is vertical to the z-axis).

As shown in FIG. 4, optionally, the height X3 of the protrusion part 40 is greater than or equal to the depth X2 of the deepening part 21. The plane in parallel with XOY plane passing through the bottom surface of the damper gel groove 2 is denoted as a plane A7. The plane in parallel with XOY plane passing through the bottom surface of the protrusion part 40 is denoted as a plane A8. The distance between the plane A7 and the plane A8 is the height X3 of the protrusion part 40. The height X3 of the protrusion part 40 is greater than or equal to the depth X2 of the deepening part 21. The configuration of the protrusion part 40 of which the height X3 is greater than or equal to the depth X2 of the deepening part 21 may prevent the thickness of the damper gel groove 2 from decreasing, and in other words, the protrusion part 40 may prevent the decreasing thickness of the bottom of the damper gel groove 2 due to the deepening of the damper gel groove 2 from declining the compressive strength of the damper gel groove 2.

As shown in FIG. 4, specifically, the thickness of the original damper gel groove is the distance between the plane A5 and the plane A7. However, the thickness of the damper gel groove 2 decreases by the depth X2 of the deepening part 21 because the depth of the deepening part 21 is removed between the plane A5 and the plane A7. At this time, the thickness of the bottom of the damper gel groove 2 further increases by the height X3 of the protrusion part 40, and the current thickness of the damper gel groove 2 (the current thickness of the damper gel groove 2 is the distance between the plane A6 and the plane A8) may remain the same because the height X3 of the protrusion part 40 is greater than or equal to the depth X2 of the deepening part 21.

As shown in FIG. 5, optionally, the damper pin body 10 in another embodiment (the damper pin body 10 may refer to FIG. 3, similarly hereinafter) includes a damper pin first body 100 and a damper pin second body 101, and the damper pin first body 100, the lengthening part 11 and the damper pin second body 101 are sequentially connected. The damper pin first body 100, the damper pin second body 101 and the damper pin tail part 12 constitute the damper pin in the prior art. The part of the damper pin 1 between the plane A1 and the plane A3 is the damper pin first body 100. The length of the damper pin first body 100 and the length of the damper pin second body 101 may arbitrarily change only if the sum of the length of the damper pin first body 100 and the length of the damper pin second body 101 remains the same as the length of the damper pin body 10. The part of the damper pin 1 located between the plane A4 and the plane A2 is the damper pin second body 101. The lengthening part 11 may be located on any position between the plane A1 and the plane A2.

As shown in FIG. 5, the damper pin first body 100, the lengthening part 11, the damper pin second body 101 and the damper pin tail part 12 may be coaxial and be integrally formed. The shape and the size of the cross section of the damper pin first body 100, the shape and the size of the cross section of the lengthening part 11 and the shape and the size of the cross section of the damper pin second body 101 may be equal. The shape of the damper pin first body 100, the shape of the lengthening part 11 and the shape of the damper pin second body 101 may be rectangular.

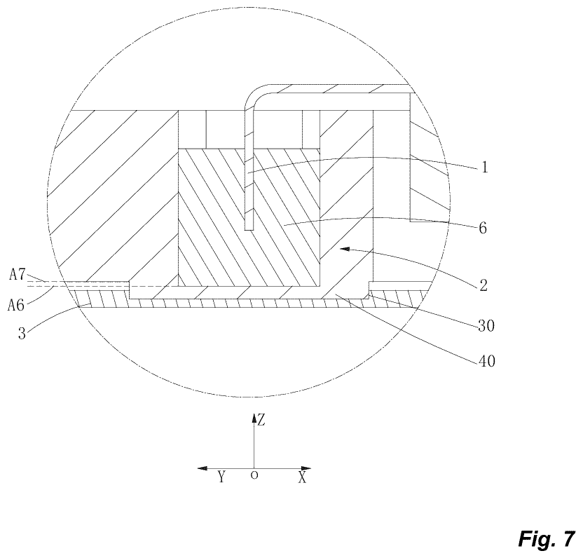

As shown in FIG. 7, in the damper device provided by the yet another embodiment, the deepening part 21 (the deepening part 21 may refer to FIG. 4, similarly hereinafter) extends to the interior of the protrusion part 40. Extending the deepening part 21 to the interior of the protrusion part 40 may be the lowest position of the deepening part 21 lower than the highest position of the protrusion part 40. Under the condition that extending the deepening part 21 of the damper gel groove 2 to the interior of the protrusion part 40 may increase the overlapping area between the damper pin 1 and the damper gel 6 in the damper gel groove 2, the height of the voice coil motor would not increase. The protrusion part 40 may be the protruding block in the prior art and may be used to bear and position the frame 4 (the frame 4 may refer to FIG. 6).

As shown in FIG. 7, the bottom position of the deepening part 21 (the deepening part 21 may refer to FIG. 4, similarly hereinafter) is lower than the top position of the protrusion part 40. The bottom surface of the deepening part 21 is also the plane A6. The top surface of the protrusion part 40 is also the plane A7. The bottom position of the deepening part 21 is lower than the top position of the protrusion part 40, and in other words, the position of the plane A6 is lower than the position of the plane A7. In the present embodiment, the size of the cross section of the deepening part 21 is lower than the size of the cross section of the protrusion part 40. The size of the cross section of the protrusion part 40 may be equal to the size of the cross section of the recession part 30.

The damper device provided by the embodiments of the present disclosure is described in detail by the above description. The person skilled in the art would have changes in specific implementation and application scope according to the idea of the embodiments of the present disclosure. In view of the above description, the content of the present disclosure should not be construed as limitations of the present disclosure, and equivalent modification or changes according to the idea and the spirit of the present disclosure should be construed as being included within the claims of the present disclosure.

### LIST OF REFERENCE SIGNS

1: damper pin
10: damper pin body
100: damper pin first body
101: damper pin second body
11: lengthening part
12: damper pin tail part
2: damper gel groove
20: damper gel groove body
21: deepening part
3: case
30: recession part
4: frame
40: protrusion part
5: motion component
6: damper gel

1. A damper device comprising:
a damper pin comprising a damper pin body, a lengthening part and a damper pin tail part which are sequentially connected;
a damper gel groove where the damper pin is inserted, wherein the damper gel groove comprises a damper gel groove body and a deepening part connected to the damper gel groove body, and a length of the lengthening part is less than or equal to a depth of the deepening part;
a frame where the damper gel groove is disposed, wherein the frame comprises a protrusion part, and the protrusion part downwardly protrudes from a bottom of the frame and is disposed under the damper gel groove; and
a case where the frame is disposed.

2. The damper device according to claim 1, wherein the damper pin body comprises a damper pin first body and a damper pin second body, and the damper pin first body, the lengthening part and the damper pin second body are sequentially connected.

3. The damper device according to claim 1, wherein a shape and a size of a cross section of the damper pin body are equal to a shape and a size of a cross section of the lengthening part.

4. The damper device according to claim 3, wherein the damper pin body and the lengthening part are coaxially disposed.

5. The damper device according to claim 1, wherein a shape and a size of a cross section of the damper gel groove body are equal to a shape and a size of a cross section of the deepening part.

6. The damper device according to claim 5, wherein the damper gel groove body and the deepening part are coaxially disposed.

7. The damper device according to claim 1, further comprising a motion component, wherein the motion component is movably disposed relative to the frame, and the motion component and the frame are separate, and the damper pin is connected to the motion component.

8. The damper device according to claim 1, wherein the protrusion part contacts the case.

9. The damper device according to claim 1, wherein the protrusion part and the damper gel groove are coaxially disposed.

10. The damper device according to claim 1, wherein a height of the protrusion part is greater than or equal to a depth of the deepening part.

11. The damper device according to claim 1, wherein the case comprises a recession part and the protrusion part is located on and contacts the recession part.

12. The damper device according to claim 11, wherein a number of the recession parts and a number of the protrusion parts are all at least four, and the recession parts are correspondingly disposed with the protrusion parts one by one.

13. The damper device according to claim 11, wherein a depth of the recession part is less than or equal to a height of the protrusion part.

14. The damper device according to claim 1, wherein the deepening part extends to the inside of the protrusion part.

15. The damper device according to claim 14, wherein a bottom position of the deepening part is lower than a top position of the protrusion part.
